(19) United States
(12) Patent Application Publication
(10) Pub. No.: US 2015/0119029 A1
(43) Pub. Date: Apr. 30, 2015

(54) METHOD AND APPARATUS FOR SEARCHING FOR RADIO FREQUENCY SIGNALS BY A SUBSCRIBER UNIT IN A WIRELESS COMMUNICATION SYSTEM

(71) Applicant: MOTOROLA SOLUTIONS, INC., Schaumburg, IL (US)

(72) Inventor: GINO A, SCRIBANO, Saint Charles, IL (US)

(21) Appl. No.: 14/528,680

(22) Filed: Oct. 30, 2014

Related U.S. Application Data
(60) Provisional application No. 61/897,692, filed on Oct. 30, 2013.

(51) Int. Cl. H04W 48/16; H04W 48/18

(52) U.S. Cl. CPC H04W 48/16; H04W 48/18; H04W 84/042
USPC 455/434

(57) ABSTRACT

A method and subscriber unit (SU) are provided that control an order in which a subscriber unit (SU) tunes to, and inspects, a frequency for a signal. When the SU activates in a wireless communication system, the SU searches for an RF signal by reference to a search list, wherein the search list maintains a prioritized list of channel numbers in association with a Public Land Mobile Network, an access technology, and a band number. In response to detecting the RF signal, the SU determines whether the RF signal is acceptable and, in response to determining that the RF signal is acceptable, connects to an access network associated with the RF signal.

### CROSS-REFERENCE TO RELATED APPLICATION

This application claims priority from U.S. Provisional Application No. 61/897,692, entitled “METHOD AND APPARATUS FOR SEARCHING FOR RADIO FREQUENCY SIGNALS BY A SUBSCRIBER UNIT IN A WIRELESS COMMUNICATION SYSTEM,” filed Oct. 30, 2013, Attorney Docket No. CM15868, which is application is commonly owned and incorporated herein by reference in its entirety.

### FIELD OF THE INVENTION

The present invention relates generally to wireless communication systems, and more specifically to a searching for radio frequency signals by a subscriber unit in a wireless communication system.

### BACKGROUND OF THE INVENTION

A radio access technology (RAT) can be UTRA (UMTS Terrestrial Radio Access), E-UTRA (Evolved UTRA) (also known as Third Generation Partnership Project Long Term Evolution (3GPP LTE)), HRPD (High Rate Packet Data), cdma2000 (code division multiple access), GSM (Global System for Mobile Communications), and so on. Radio frequency (RF) is a variable measured in hertz (Hz) or multiples (kHz, MHz, GHz . . . ) corresponding to a piece of the radio spectrum where a RF transmission and/or RF reception occurs. During at least short term operation of subscriber units and infrastructure the frequency does not change. The part of the radio spectrum around a given frequency is called an ‘operating band’ or a ‘band class.’ Operating bands are assigned distinct numbers to be able to tell them apart, and the numbering scheme depends on the access technology employing the operating band. In general, operating bands are fairly wide, containing several “channels.” Each channel has a channel number assigned to it and a constant frequency. The numbering scheme for the channel also depends on the access technology which will use the frequency corresponding to that channel. The exact frequency of a channel can be computed when the band class and the channel number are known.

By way of example, under a first RAT, the frequency 830 kHz may belong to band class 10 and correspond with channel #26, while frequency 890 kHz may belong to the same band class 10 and correspond with channel #36. Under a second RAT, the frequency 830 kHz may belong to band class 15 and correspond with channel #12, while the frequency 890 kHz may belong to band class 7 and correspond with channel #40.

When a subscriber unit (SU) powers up, that is, activates, the SU must search bands and channels that it is capable of supporting for an RF control signal with minimal configuration assistance regarding an order of the search, with the result that the search is not manageable in accordance with other search criteria resulting in inefficient searching and potentially an uneven distribution of SUs across the system. Such searching can be time consuming and battery depleting, and may result in a sub-optimal distribution of SUs among available bands and RATs.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless communication system in accordance with various embodiments of the present invention.

FIG. 2 is a block diagram of a subscriber unit of FIG. 1 in accordance with an embodiment of the present invention.

FIG. 3 is an illustration of an exemplary version of the search list, or table, of the subscriber unit of FIG. 2 in accordance with an embodiment of the present invention.

FIG. 4 is an illustration of an exemplary version of the search list, or table, of the subscriber unit of FIG. 2 in accordance with another embodiment of the present invention.

FIG. 5 is a logic flow diagram illustrating a method executed by a subscriber unit of FIG. 1 in searching for radio frequency signal upon activation in accordance with an embodiment of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE INVENTION

To address the need that exists for an improved scheme for channel selection upon power up of a subscriber unit (SU) in a public safety communication system, a method and apparatus is provided that control an order in which a subscriber unit (SU) tunes to, and inspects, a frequency for a signal. More particularly, when the SU activates in a wireless communication system, the SU searches for a radio frequency (RF) signal by reference to a search list, wherein the search list maintains a prioritized list of channel numbers in association with a Public Land Mobile Network (PLMN), an access technology, and a band number. In response to detecting the RF signal, the SU determines whether the RF signal is acceptable and, in response to determining that the RF signal is acceptable, connects to an access network associated with the RF signal.

Generally, an embodiment of the present invention encompasses a method for searching for an RF signal by an SU in a wireless communication system. The method includes activating in a wireless communication system, in response to activating, searching for a RF signal by reference to a search list, wherein the search list maintains a prioritized list of channel numbers in association with a PLMN, an access technology, and a band number, detecting the RF signal, determining whether the RF signal is acceptable, and in response to determining that the RF signal is acceptable, connecting to an access network associated with the RF signal.

Another embodiment of the present invention encompasses an SU comprising a processor and one or more memory devices that are configured to store a search list comprising a prioritized list of channel numbers, wherein each channel number in the prioritized list of channel numbers is maintained in association with a PLMN, an access technology, and a band number. The one or more memory devices further are configured to store instructions that, when executed by the processor, cause the processor to in response to an activation of the SU, search for an RF signal by reference to the search list, detect the RF signal, determine whether the RF signal is acceptable, and in response to determining that the RF signal is acceptable, connect to an access network associated with the RF signal.

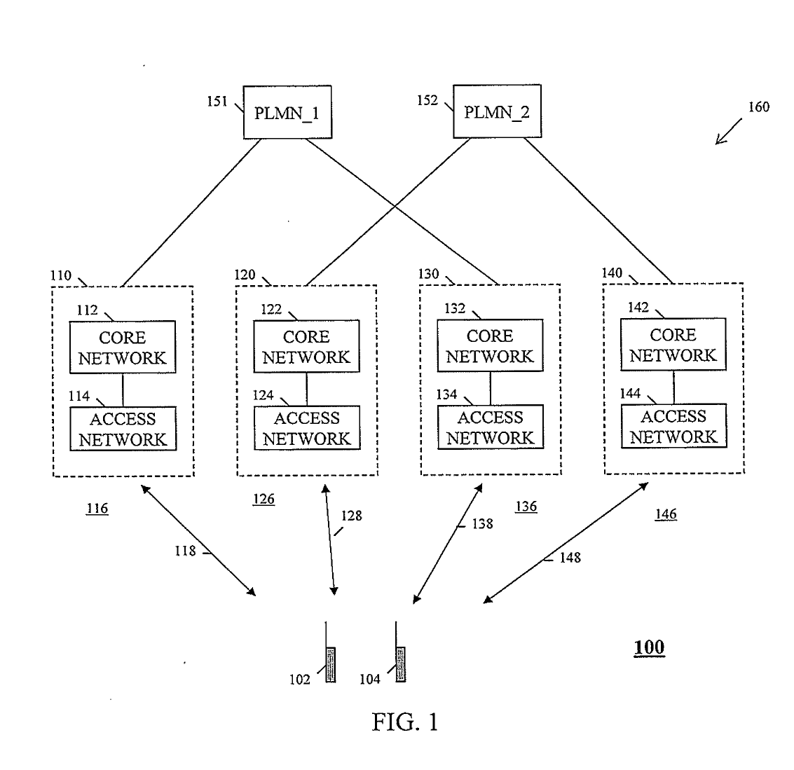

Turning now to the drawings, the present invention may be more fully described with reference to FIGS. 1-5. FIG. 1 is a block diagram of a wireless communication system 100 in accordance with various embodiments of the present invention. Communication system 100 includes multiple subscriber units (SUs) 102, 104 (two shown), which also are referred to in the art as subscribers, user equipment (UE), communication devices, access terminals, mobile terminals, mobile stations, mobile subscriber units, mobile devices, user devices, and the like. The SUs 102, 104, 106 can be any type of communication device such as radios, mobile phones, mobile data terminals, Personal Digital Assistants (PDAs), laptops, two-way radios, cell phones, personal computer (PC) or laptop computer equipped for wireless communications, and any other device capable of operating in a wireless environment and that can be used by a user in the system. Further, each of the multiple SUs 102, 104 is a multi-mode, multi-band device, that is, supports wireless communications over multiple wireless technologies and multiple frequency bands.

Communication system 100 further includes an infrastructure 160 that includes multiple Public Land Mobile Networks (PLMNs) 151, 152 (two shown) that are each associated with multiple wireless networks 110, 120, 130, 140 (four shown). For example, as depicted in FIG. 1, PLMN 151 is associated with wireless networks 110 and 130 (i.e., an operator of PLMN 151 also operates wireless networks 110 and 130) and PLMN 152 is associated with wireless networks 120 and 140. Each wireless network 110, 120, 130, 140 includes a respective core network 112, 122, 132, 142 coupled to a respective access network 114, 124, 134, 144. In practice, two or more access networks can be connected to the same core network and vice-versa. For example, in a Third Generation Partnership Project (3GPP) Long Term Evolution (LTE) wireless network, the core network may be an Evolved Packet Core (EPC) that may include a Mobility Management Entity (MME), multiple gateways, such as a Serving Gateway and a Public Data Network Gateway (PDN GW), a Policy Control and Charging Rules Function (PCRF), and a Home Subscriber Server (HSS). In another embodiment of the present invention, a core network associated with a PLMN may serve multiple access networks of the PLMN, for example, core network 112 associated with PLMN 151 may serve both access network 114 and access network 134.

Each access network 114, 124, 134, 144 includes one or more access nodes (not shown), such as a base station (BS), a node B, an eNodeB (eNB), an access point (AP), or any other wireless network access node known in the art. The access nodes provide wireless communication services to SUs, such as SUs 102 and 104, located in a corresponding coverage area, for example, a cell or a cell sector, of the access node, such as coverage areas 116, 126, 136, and 146 of access networks 114, 124, 134, and 144, via a corresponding air interface 118, 128, 138, and 148. It is assumed herein that SUs 102 and 104 each resides in the coverage areas 116, 126, 136, 146 of each access network 114, 124, 134, 144. Each air interface 118, 128, 138, and 148 includes a forward link that includes multiple traffic channels, such as, shared, dedicated, and default bearers, and forward link common and dedicated control channels. Each air interface 118, 128, 138, and 148 further includes a reverse link that includes multiple traffic channels, such as shared, dedicated, and default bearers, and reverse link common and dedicated control channels. The forward and reverse link may be on the same frequency, with transmissions and reception multiplexed in time.

For the purpose of illustrating the principles of the present invention, each wireless network associated with a PLMN, such as wireless networks 110 and 130 with respect to PLMN 151 and wireless networks 120 and 140 with respect to PLMN 152, implements a different radio access technology (RAT) than the other wireless networks associated with that PLMN. For example, wireless network 110 associated with PLMN 151 may implement a first RAT that operates over first frequency that is associated with a first ‘band class’ (also referred to herein as a ‘band’) (e.g., a band class #10) and a first ‘channel’ (e.g., a channel #26), and over a second frequency that is associated with a second band class (e.g., a band class #12) and a second channel number (e.g., a channel #36). In some embodiments, the first and second band classes may be the same, but the channels are different. Wireless network 130, also associated with PLMN 151, may implement a second RAT that operates over third frequency, associated with a third band class (e.g., a band class #15) and a third channel (e.g., a channel #12), and over a fourth frequency, associated with a fourth band class (e.g., a band class #7) and a fourth channel (e.g., a channel #40). Similarly, in some embodiments, the third and fourth band classes may be the same, but the channels are different. Further, one or more of the first frequency and the second frequency may be the same as the third frequency or the fourth frequency. But as these are different RATs, the assignment of band class numbers and channel numbers to each frequency typically is different even if the frequencies are the same, as the band class and channel terminology typically has evolved independently for each RAT. Thus a frequency in each RAT may be identified by its band class number and channel number, which band class number and channel number associated with that frequency may be different from RAT to RAT.

Similarly, wireless network 120 associated with PLMN 152 may implement a third RAT, which may or may not be the same as the first or second RAT, that operates over fifth frequency that is associated with a fifth band class (e.g., a band class #14) and a fifth channel (e.g., a channel #9), and over a sixth frequency that is associated with a sixth band class (e.g., a band class #17) and a sixth channel (e.g., a channel #21). Again, in some embodiments, the fifth and sixth band classes may be the same, but the channels are different. And wireless network 140, also associated with PLMN 152, may implement a fourth RAT that operates over seventh frequency, associated with a seventh band class (e.g., a band class #6) and a seventh channel (e.g., a channel #13), and over an eighth frequency, associated with a eighth band class (e.g., a band class #13) and an eighth channel (e.g., a channel #25). Similarly, in some embodiments, the seventh and eighth band classes may be the same, but the channels are different. Further, one or more of the fifth frequency and the sixth frequency may be the same as the seventh frequency or the eighth frequency. But, again, as these are different RATs, the assignment of band class numbers and channel numbers to each frequency typically is different between the RATs even if the frequencies are the same.

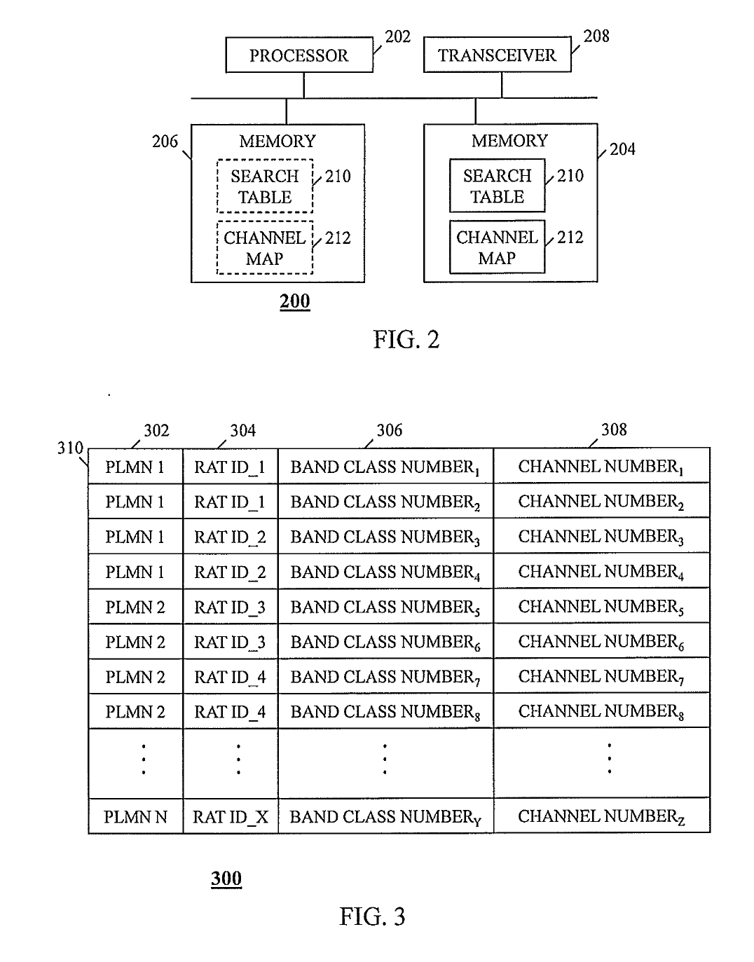

Referring now to FIG. 2, a block diagram is provided of an SU 200, such as SUs 102 and 104, in accordance with various embodiments of the present invention. SU 200 includes a processor 202, such as one or more microprocessors, microcontrollers, digital signal processors (DSPs), combinations thereof or such other devices known to those having ordinary skill in the art, which processor is configured to execute the functions described herein as being executed by the SU. SU 200 further includes multiple memory devices 204, 206 (two shown), such as random access memory (RAM), dynamic random access memory (DRAM), and/or read only memory (ROM) or equivalents thereof. A first memory device 204 of the multiple memory devices 204, 206 is a memory card, such as a Universal Integrated Circuit Card (UICC) or a subscriber identity module (SIM) card, which may or may not be removable. Further, memory cards such as a SIM card are also known to include an embedded processor, and the functionality referenced to herein as being performed by processor 202 may include functionality performed by such an embedded processor (which shall be deemed herein to be included in references to processor 202). A second memory device 206 of the multiple memory devices 204, 206 may be permanently affixed in the SU. SU 200 further includes a radio frequency (RF) transceiver 208 that includes one or more RF receivers (not shown) and one or more RF transmitters (not shown) capable of exchanging wireless messaging with the access nodes of each of access networks 114, 124, 134, and 144.

Each of the multiple memory devices 204, 206 is accessible by processor 202 and maintains data and programs/instructions that may be executed by the processor and that allows the SU to perform all functions necessary to operate in communication system 100. Further, memory card 204 further maintains a search list, or table, 210 that controls an RF signal search performed by the SU upon activation. Search list 210 maintains a prioritized list of channel numbers, wherein each channel number is maintained in association with a PLMN, an access technology, and a band number associated with the channel number. When the SU activates, the SU searches for an RF signal in an order identified by the list of channel numbers in the search list and by reference to a channel map 212 that maps each PLMN/RAT/band number/channel number combination listed in search list 210 to a frequency. That is, by reference to search list 210, the SU can determine a channel to search for an RF signal upon activation in communication system 100, and by reference to channel map 212, the SU can determine the frequency associated with that channel number so that the SU knows the frequency to tune to in order to detect the RF signal.

In other embodiments of the present invention, one or both of search list 210 and channel map 212 may be maintained in second memory device 206 of the SU. The SU may be pre-provisioned with search list 210 and channel map 212 by an operator of communication system 100, or an operator of communication system 100 may convey the search list 210 and/or channel map 212 to the SU, and/or modify a search list 210 and/or channel map 212 maintained by the SU, over the air, for example, by use of the USAT (USim Application Toolkit) to have the list(s) updated on the USIM. It is also possible that the SU displays the contents of the list (or parts of it), in human readable format, to a human user, allowing him/her to make selections and changes, including priority order, and apply the changes to the search process, with or without storing the modified data in the USIM.

In various embodiments of the present invention, the search list 210 maintained by one SU, such as SU 102, may or may not be different from the search list 210 maintained by another SU, such as SU 104. For example, the search list of an SU may prioritize the channels to be searched and/or may include a list of channels to be searched that is different from the search list of another SU. By varying the priorities of the channels to be searched from SU to SU so that one SU will search among the channels in a different order than another SU, and/or by including a different list of channels to be searched for each SU, communication system 100 may control a distribution of the load of the access networks of communication system 100, distributing the UEs among the various access networks such that congestion is minimized.

The functionality described herein as being performed by each of SUs 102 and 104 is implemented with or in software programs and instructions stored in the multiple memory devices 204, 206 of the SU and executed by processor 202 of the SU. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the SU. Based on the present disclosure, one skilled in the art will be readily capable of producing and implementing such software and/or hardware without undue experimentation.

Applications which commonly reside on a memory card 204 of an SU are a Universal Subscriber Identity Module (USIM) and an IP (Internet Protocol) Multimedia Subsystem Subscriber Identity Module (ISIM). The memory card 204 can be “read,” and “written” to, by the SU. The data that is usually placed on the memory card 204 includes “permanent data” (e.g., a phone number, an SU identifier (e.g., an International Mobile Subscriber Identity (IMSI)), a wireless system operator (e.g., Verizon, AT&T, T-Mobile), etc.) which has to be available to the SU after the SU powers off and re-powers on. Occasionally, the SU displays data from the memory card 204 to the user, allows the user to modify data on memory card 204, and writes the modified data back on memory card 204.

The data on memory card 204 is organized in individually retrievable structures called Elementary Files (EFs). Some EFs are required to always be present (‘mandatory”), others EFs are not (“optional”), while still other EFs (“conditional”) may be present only if some condition is met (e.g., the presence of another EF). Usually the data on the memory card (i.e., the EFs) is considered “configuration” and is produced and written by the system operator on “blank” or “empty” cards that the system operator obtains from the smart card vendor. The SU may be sold by the system operator together with the SIM card, or the user may buy the SU and the card separately, have the card configured by the system operator at an operator site, and then insert the configured card in the SU. Occasionally the system operator can perform initial configuration or subsequent re-configuration of a memory card remotely, e.g., “over the air” (OTA). To write on memory card 204, one would use the USAT (USim Application Toolkit).

The order in which an SU, such as SUs 102 and 104, tunes to, and inspects, various frequencies for RF signal/service acquisition upon activation, or power-on, is encoded in, among other files, three elementary files (EFs) on the memory card 204. These EFs are called “User controlled PLMN selector with Access Technology and Frequency,” “Operator controlled PLMN selector with Access Technology and Frequency,” and “HPLMN selector with Access Technology and Frequency.” Together, these three EFs may be referred to as “PLMN selector with Access Technology and Frequency.” Each of these three EFs is a list of entries, with each entry in the list consisting of four data fields: a first data field comprising a PLMN (Public Land Mobile Network) identifier (ID), a second data field comprising an Access Technology ID, a third data field comprising the operating band number, and a fourth data field comprising the channel number. The PLMN ID, typically represented as a concatenation of mobile country code (MCC) and mobile network code (MNC), typically uniquely identifies the system operator, the Access Technology ID uniquely identifies the access technology (e.g., UTRA or E-UTRA), and the operating band number and channel number may be used to compute a frequency to scan. The three EFs, or lists, are each ordered in descending order of the preference for the associated system operator to provide service. Specific rules (some explicitly prescribed in the standards and some left to the implementation) are used to derive, from these three EFs, the exact order of tuning to RF frequencies, searching for a signal emitted from a cell site, and reading the PLMN ID which is encoded in the signal emitted from the cell site. These elementary files, for example, the “Operator controlled PLMN selector with Access Technology and Frequency” list, can be modified by the SU which may replace this list with another one (e.g., via USAT with REFRESH command).

When an SU, such as SUs 102 and 104 activates, that is, powers-on, in communication system 100, the SU first tunes to a frequency and starts looking (using a specific radio access technology (RAT)) for a recognizable and identifiable radio frequency (RF) signal from an access network, such as access networks 114, 124, 134, and 144, of infrastructure 160. If the SU does not find any RF signal, or finds RF signals that are too weak or too noisy, the SU tunes to another frequency and starts anew, and may repeat this again and again until the SU finds an acceptable, that is, suitable or acceptable, signal. Only after the SU finds a suitable/acceptable signal can the SU provide service to a user of the SU.

In order to control the search performed by the SU upon activation, communication system 100 provides the SU with an ordered list, or table, of PLMNs, RATs, band classes, and channels to scan. Referring now to FIG. 3, an exemplary version 300 of search list, or table, 210 is illustrated in accordance with an embodiment of the present invention. Each row 310 of list 300 is a separate search item that identifies a specific RF signal to be searched. For example, in a first row of list 300, a first data field (of a first column 302) includes a PLMN identifier, a second data field (of a second column 304) includes an identifier of a RAT associated with the PLMN, a third data field (of a third column 306) that includes an identifier of a band class associated with the RAT, and a fourth data field (of a fourth column 308) includes an identifier of a channel number associated with the band class. Generally, these four data fields may be equated to the “PLMN selector with Access Technology and Frequency” elementary files (EFs) described above.

For example, in a first row of list 300, the data field of the first column 302 includes an identifier of a PLMN, that is, ‘PLMN 1’ (e.g., PLMN 151), the data field of the second column 304 includes an identifier of a RAT of PLMN 1, that is, ‘RAT ID 1’ (e.g., the RAT associated with access network 114), the data field of the third column 306 includes a band class number associated with RAT ID1, that is, ‘Band Class Number₁’ (e.g., band class 10), and the data field of the fourth column 308 includes a channel number associated with the band class, that is, ‘Channel Number₁’ (e.g., a channel 26). And a second row of table 300 also includes the PLMN identifier ‘PLMN 1’ (i.e., PLMN 151) and the RAT identifier ‘RAT ID 1’ (i.e., the RAT associated with access network 114), but includes the band class number ‘Band Class Number₂’ (e.g., band class 12) and the channel number ‘Channel Number₂’ (e.g., a channel 36).

Further, the rows of list 300 are hierarchically ordered, that is, the higher the row, the higher the priority of the PLMN/RAT/Band Class/Channel Number combination. While the rows of list 300 are depicted as being grouped by PLMNs and then sub-grouped by RATs, this is merely for illustrative purposes and the rows may be ordered in any order as determined by an operator of the system. For example, the second row, which lists the combination PLMN 1/RAT ID 1/Band Class Number₂/Channel Number₂, may instead list the combination PLMN 2/RAT ID 4/Band Class Number₄/Channel Number₄.

Accordingly, when an SU, such as SUs 102 and 104, activates, the SU may search for an acceptable channel in an order indicated by the list 300. For example, when an SU, such as SUs 102 and 104, activates, the SU may first search for Channel Number₁ of Band Class Number₁ of RAT ID 1 of PLMN 1, as identified in the first row of list 300; if that channel is not acceptable, then the SU may search for Channel Number₂ of Band Class Number₂ of RAT ID 1 of PLMN 1, as identified in the second row of list 300; if that channel is not acceptable, then the SU may search for Channel Number₃ of Band Class Number₃ of RAT ID 2 of PLMN 1, as identified in the third row of list 300; and so on, working its way down the table.

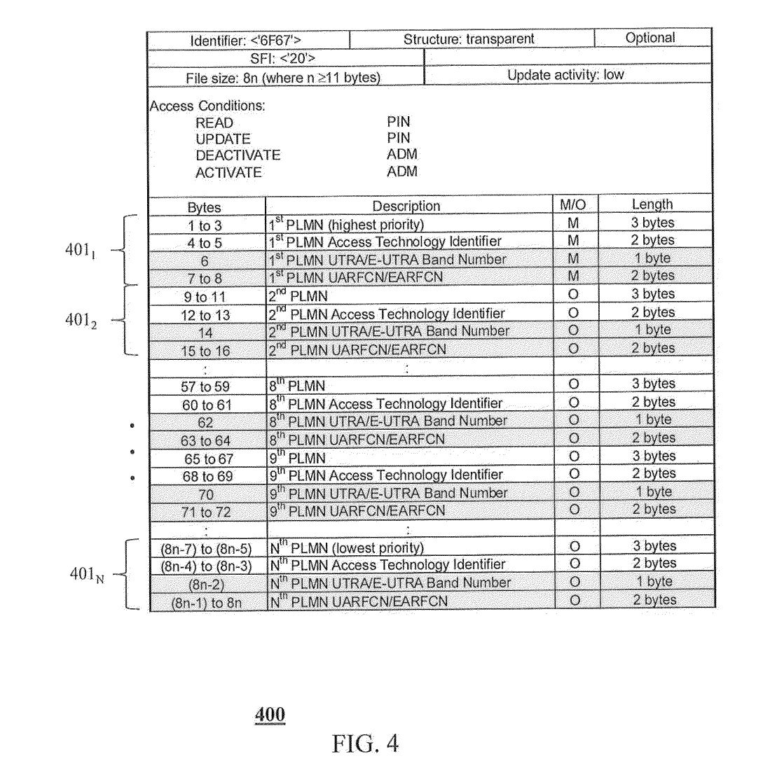

Referring now to FIG. 4, an exemplary version 400 of search list, or table, 210 is illustrated in accordance with another embodiment of the present invention. As depicted in FIG. 4, each search item 401₁-401_{N} comprises four rows that identify a specific RF signal to be searched. For example, with respect to search item 401₁, a first row of search item 401₁ comprises a first data field that includes an identifier of a PLMN and a second data field that identifies a number of bytes of the first data field. A second row of search item 401₁ comprises a third data field that includes an identifier of an access technology of the PLMN of the first row (e.g., UTRA (UMTS Terrestrial Radio Access) or E-UTRA (evolved UTRA)) to be searched and a fourth data field that identifies a number of bytes of the third data field. A third row of search item 401₁ comprises a fifth data field that includes a Band Number (“UTRA/E-UTRA Band Number”) of the access technology of the second row to be searched, and a sixth data field that identifies a number of bytes of the third data field. And a fourth row of search item 401₁ comprises a seventh data field that includes a Channel Number (“UARFCN (UTRA Absolute Radio Frequency Channel Number)/EARFCN (E-UTRA Absolute Radio Frequency Channel Number)”) of the Band Number of the third row to be searched. Generally, these four rows may be equated to the “PLMN selector with Access Technology and Frequency” elementary files (EFs) described above. Length data fields, together with a mandatory/optional (M/O) data field and a “Bytes” data field, are shown in FIG. 4 for clarity only. If technologies other than UTRA and E-UTRA are used, different designations may be used for the channels. It is also possible to store the band class number and channel number information in conditional elementary files separate from the priority list of PLMN and RAT elementary files, with the priority list given by row matching between these files.

Similar to list 300, the search items of list 400 are hierarchically ordered, that is, the higher the search item in the table, the higher the priority of the PLMN/RAT/Band Class/Channel Number. For example, search item 401₁ is higher priority than search item 401₂ and so on down to search item 401_{N}.

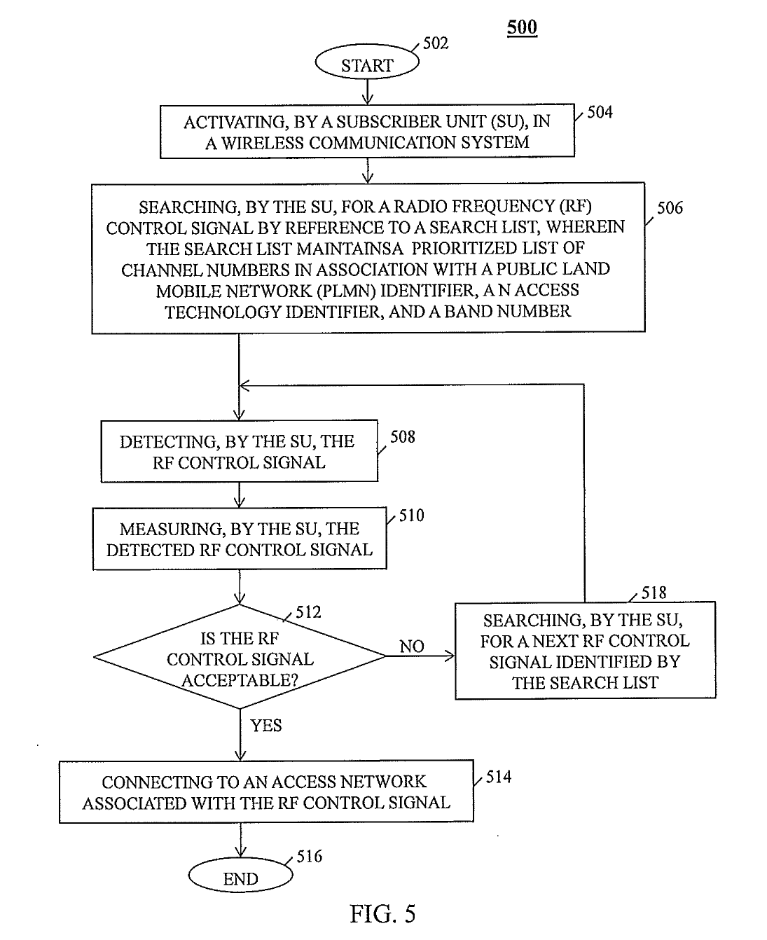

Referring now to FIG. 5, a logic flow diagram 500 is provided that illustrates a method performed by an SU, such as SUs 102 and 104, in searching for an RF control signal upon activation in accordance with an embodiment of the present invention. Logic flow diagram 500 begins (502) when an SU, for example, SU 102, activates (504) in communication system 100. Upon activation, SU 102 searches (506) for a control signal, for example, a system information signal, a pilot or reference signal, a beacon, or any other system overhead signal, by reference to the search list 210 maintained in the multiple memory devices 204, 206, of the SU. That is, search list 210 includes a prioritized list of channels to be searched by an SU upon activation, wherein each channel number is maintained, in the search list, in association with a Public Land Mobile Network, an access technology, and a band number associated with that channel number. For example, when SU 102 activates, the SU first searches a top priority channel in the search list (e.g., the first channel listed in the search list) for an RF signal based on the PLMN, RAT, band number, and channel number listed. That is, after determining the PLMN, RAT, band number, and channel number by reference to search list 210, SU 102 then determines a frequency to tune to detect the signal by reference to channel map 212, which maps each PLMN/RAT/band number/channel number combination included in search list 210 to a frequency.

In response to determining the PLMN/RAT/band number/channel number to search and the corresponding frequency, SU 102 then monitors the determined frequency and detects (508) an overhead RF signal transmitted by infrastructure 160 over that frequency. In response to detecting the RF signal, SU 102 determines (510) whether the RF signal is of acceptable, that is, suitable or acceptable, quality. For example, SU 102 may determine a signal quality metric associated with the RF signal, such as a signal strength of the signal (for example, a received signal strength indication (RSSI), a signal-to-noise ratio (SNR)), a signal-to-noise plus interference ratio (SINR), a carrier-to-interference-plus-noise ratio (CINR), a bit energy-to-noise density ratio (Eb/Io), a bit error rate, or a frame error rate associated with the RF signal.

When the determined signal quality metric compares favorably to a signal quality metric threshold, for example, when a signal strength of the received signal is greater than a received signal strength threshold, or a measured SNR/SINR/CINR associated with the received signal is greater than a corresponding SNR/SINR/CINR threshold, or a bit error rate or frame error rate is less than a bit error rate or frame error rate threshold, then SU 102 connects (514) to the corresponding access network associated with (i.e., sourcing) the RF signal, and logic flow 500 then ends (516). However, when the determined signal quality metric compares unfavorably to the signal quality metric threshold, for example, when the signal strength of the received signal is less than the received signal strength threshold, or the measured SNR/SINR/CINR associated with the received signal is less than the corresponding SNR/SINR/CINR threshold, or the bit error rate or frame error rate is greater than the bit error rate or frame error rate threshold, then SU 102 searches (518) a next priority channel in the search list (e.g., the next channel listed in the search list below the channel just searched) for an RF signal based on the PLMN, RAT, band number, and channel number listed of that next channel. That is, the SU determines the PLMN, RAT, band number, and channel number of the next priority channel by reference to search list 210 and determines a frequency to tune to detect that signal by reference to channel map 212. Logic flow diagram then returns to step 508, and may continue to repeat this process until the list of channels in search list 210 is exhausted.

By searching for an RF signal based on the prioritized listing of PLMNs, RATs, band numbers, and channel numbers channels in search map 210, SU may search channels in an ordered and efficient manner. Further, by providing SU 102 with such a search map, an operator of communication system 100 may configure the search done by the SU and may better distribute SUs among available bands and RATs, as opposed to all SUs searching RATs and bands in a same order, resulting in congestion in the RATs and bands first searched.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for searching for a radio frequency (RF) signal by a subscriber unit in a wireless communication system, the method comprising:
activating in a wireless communication system;
in response to activating, searching for a RF signal by reference to a search list, wherein the search list maintains a prioritized list of channel numbers in association with a Public Land Mobile Network, an access technology, and a band number;
detecting the RF signal;
determining whether the RF signal is acceptable; and
in response to determining that the RF signal is acceptable, connecting to an access network associated with the RF signal.

2. The method of claim 1, further comprising:
deriving a frequency of the radio frequency (RF) signal based on the channel number.

3. The method of claim 1, further comprising:
in response to determining that the RF signal is unacceptable, searching for another radio frequency (RF) signal by reference to the search list.

4. The method of claim 3, wherein the radio frequency (RF) signal is a first RF signal, the another RF signal is a second RF signal, and the first RF signal is prioritized higher in the search list than the second RF signal.

5. The method of claim 1, wherein the search list comprises, for a same radio frequency, a first channel number in association with a first access technology and a second, different channel number in association with a second access technology.

6. The method of claim 1, further comprising:
maintaining the search list in a memory device of the subscriber unit.

7. The method of claim 6, wherein an order in which the subscriber unit searches for radio frequency (RF) signals in response to activating is encoded in one or more elementary files.

8. The method of claim 7, wherein the one or more elementary files comprise one or more of a ‘User controlled PLMN selector with Access Technology and Frequency’ file, an ‘Operator controlled PLMN selector with Access Technology and Frequency’ file, and an ‘HPLMN selector with Access Technology and Frequency’ file.

9. The method of claim 7, wherein the one or more elementary files are ordered in an order of preference for an associated system operator to provide service.

10. The method of claim 1, further comprising:
subsequent to storing the search list, receiving a reconfiguration of the search list from a system operator; and
updating the search list based on the received reconfiguration.

11. A subscriber unit (SU) comprising:
a processor;
one or more memory devices that are configured to store a search list comprising a prioritized list of channel numbers, wherein each channel number in the prioritized list of channel numbers is maintained in association with a Public Land Mobile Network, an access technology, and a band number; and
wherein the one or more memory devices further are configured to store instructions that, when executed by the processor, cause the processor to:
in response to an activation of the SU, search for a radio frequency (RF) signal by reference to the search list;
detect the RF signal;
determine whether the RF signal is acceptable; and
in response to determining that the RF signal is acceptable, connect to an access network associated with the RF signal.

12. The subscriber unit of claim 11, wherein the Public Land Mobile Network (PLMN) is associated with, in the search list, a plurality of access technologies and wherein each access technology of the plurality of access technologies is associated with, in the search list, a plurality of band numbers.

13. The subscriber unit of claim 11, wherein the one or more memory devices further are configured to store instructions that, when executed by the processor, cause the processor to:
deriving a frequency of the radio frequency (RF) signal based on the channel number.

14. The subscriber unit of claim 11, wherein the one or more memory devices further are configured to store instructions that, when executed by the processor, cause the processor to:
in response to determining that the RF signal is unacceptable, searching for another radio frequency (RF) signal by reference to the search list.

15. The subscriber unit of claim 14, wherein the radio frequency (RF) signal is a first RF signal, the another RF signal is a second RF signal, and the first RF signal is prioritized higher in the search list than the second RF signal.

16. The subscriber unit of claim 11, wherein the search list comprises, for a same radio frequency, a first channel number in association with a first access technology and a second, different channel number in association with a second access technology.

17. The subscriber unit of claim 11, wherein an order in which the subscriber unit searches for radio frequency (RF) signals in response to activating is encoded in one or more elementary files.

18. The subscriber unit of claim 17, wherein the one or more elementary files comprise one or more of a ‘User controlled PLMN selector with Access Technology and Frequency’ file, an ‘Operator controlled PLMN selector with Access Technology and Frequency’ file, and an ‘HPLMN selector with Access Technology and Frequency’ file.

19. The subscriber unit of claim 17, wherein the one or more elementary files are ordered in an order of preference for an associated system operator to provide service.

20. The subscriber unit of claim 11, further comprising:
a transceiver that is configured to receive a search list reconfiguration from a system operator; and
wherein the one or more memory devices further are configured to store instructions that, when executed by the processor, cause the processor to, in response to receiving the search list reconfiguration, perform a reconfiguration of the search list.
